(19) United States
(12) Patent Application Publication
(10) Pub. No.: US 2026/0110420 A1
(43) Pub. Date: Apr. 23, 2026

(54) HIGH-LUMINOUS-EFFICIENCY FRAMELESS PANEL LIGHT

(71) Applicant: Xiamen PVTECH Co., Ltd., Xiamen (CN)

(72) Inventors: WEIMING GUO, Xiamen (CN); LIANGLIANG CAO, Xiamen (CN); FUXING LU, Xiamen (CN)

(21) Appl. No.: 19/362,450

(22) Filed: Oct. 19, 2025

(30) Foreign Application Priority Data
Oct. 21, 2024 (CN) 202422542674.6

(51) Int. Cl. F21V 17/06; F21V 5/00; F21V 23/00; F21Y 105/16; F21Y 113/00; F21Y 115/10

(52) U.S. Cl. CPC F21V 17/06; F21V 5/002; F21V 23/003; F21Y 2105/16; F21Y 2113/00; F21Y 2115/10

(57) ABSTRACT

A high-luminous-efficiency frameless panel light includes a housing, a light-emitting module and a diffusion plate. The housing has an opening. The light-emitting module includes a back plate disposed inside the housing through the opening and a plurality of light sources. The back plate has a light outlet, and the light sources are disposed inside the back plate through the light outlet. The diffusion plate is disposed on the housing and covers the light-emitting module. The diffusion plate has a light inlet, and the light inlet is in communication with the light outlet. The area of the light inlet is greater than the area of the light outlet.

### TECHNICAL FIELD

The disclosure relates to a panel light, in particular to a high-luminous-efficiency panel light.

### BACKGROUND

Panel lights are not only aesthetically pleasing in appearance but also capable of effectively providing illumination, and thus have been comprehensively applied in various buildings. However, in currently available panel lights, the light is easily blocked by the frame, which reduces the light-emitting area of the panel light and further decreases the luminous efficiency of the panel light.

In order to address the above problem, many lighting device manufacturers have designed frameless panel lights. However, most existing frameless panel lights adopt a narrow-frame structure. The above structure is achieved by shortening the frame size, but the light of the panel light is still easily blocked by the frame, and the above problem cannot be effectively solved. Some currently available frameless panel lights are provided with a side light-emitting function, but the structure for implementing the side light-emitting function is relatively complicated, which significantly increases the cost.

In addition, the structure for the side light-emitting function may also cause luminous flux loss, making it impossible to achieve high luminous efficiency and failing to effectively solve the above problem.

### SUMMARY

One embodiment of the disclosure provides a high-luminous-efficiency frameless panel light, which includes a housing, a light-emitting module and a diffusion plate. The housing has an opening. The light-emitting module includes a back plate disposed inside the housing through the opening and a plurality of light sources. The back plate has a light outlet, and the light sources are disposed inside the back plate through the light outlet. The diffusion plate is disposed on the housing and covers the light-emitting module. The diffusion plate has a light inlet, and the light inlet is in communication with the light outlet. The area of the light inlet is greater than the area of the light outlet.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF DRAWINGS

The disclosure will become more fully understood from the detailed description given herein below and the accompanying drawings which are given by way of illustration only, and thus are not limitative of the disclosure and wherein:

FIG. 1 is a perspective view of a high-luminous-efficiency frameless panel light in accordance with a first embodiment of the disclosure.

FIG. 2 is a first schematic view of the high-luminous-efficiency frameless panel light in accordance with the first embodiment of the disclosure.

FIG. 3 is a second schematic view of the high-luminous-efficiency frameless panel light in accordance with the first embodiment of the disclosure.

FIG. 4 is a sectional view of the high-luminous-efficiency frameless panel light in accordance with the first embodiment of the disclosure.

FIG. 5 is a partially enlarged view of the high-luminous-efficiency frameless panel light in accordance with the first embodiment of the disclosure.

FIG. 6 is a first partially enlarged view of a high-luminous-efficiency frameless panel light in accordance with a second embodiment of the disclosure.

FIG. 7 is a second partially enlarged view of the high-luminous-efficiency frameless panel light in accordance with the second embodiment of the disclosure.

FIG. 8 is a perspective view of a high-luminous-efficiency frameless panel light in accordance with a third embodiment of the disclosure.

FIG. 9 is a sectional view of the high-luminous-efficiency frameless panel light in accordance with the third embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

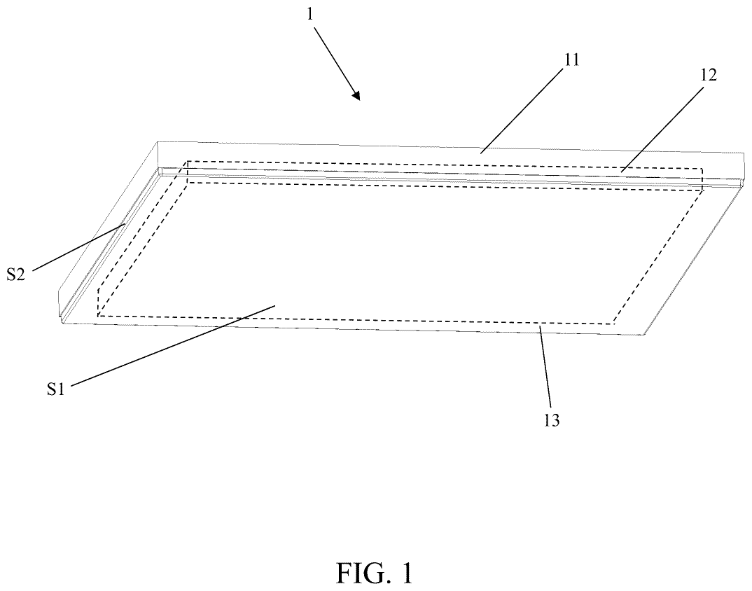

Please refer to FIG. 1, which is a perspective view of a high-luminous-efficiency frameless panel light in accordance with a first embodiment of the disclosure. As shown in FIG. 1, the panel light 1 includes a housing 11, a light-emitting module 12, and a diffusion plate 13. The light-emitting module 12 is disposed inside the housing 11, and the diffusion plate 13 is disposed on the housing 11 and covers the light-emitting module 12.

The embodiment just exemplifies the disclosure and is not intended to limit the scope of the disclosure; any equivalent modification and variation according to the spirit of the disclosure is to be also included within the scope of the following claims and their equivalents.

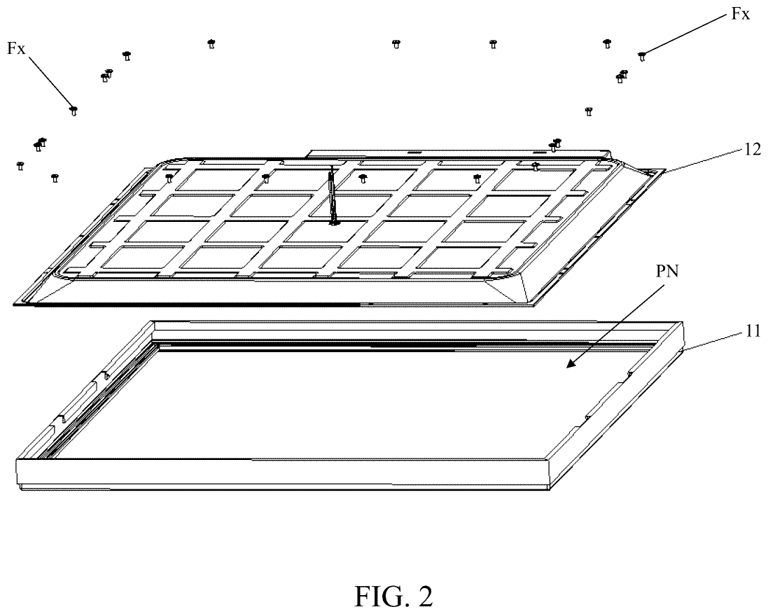

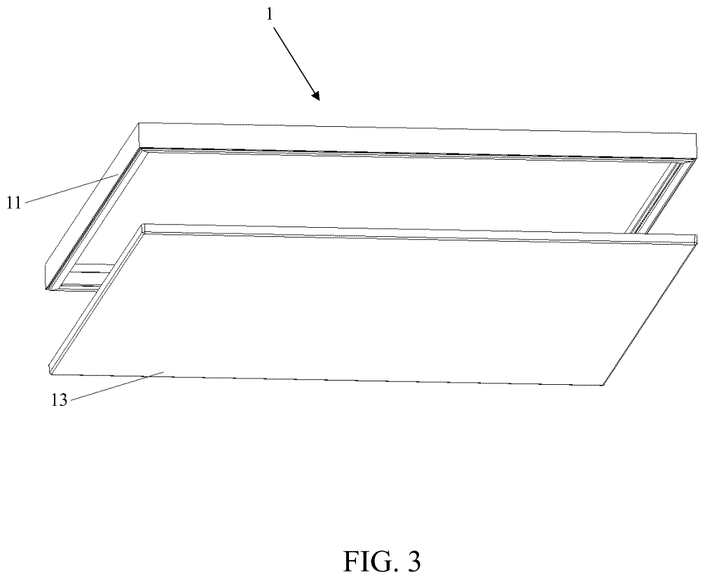

Please refer to FIG. 2 and FIG. 3. FIG. 2 is a first schematic view of the high-luminous-efficiency frameless panel light in accordance with the first embodiment of the disclosure. FIG. 3 is a second schematic view of the high-luminous-efficiency frameless panel light in accordance with the first embodiment of the disclosure. As shown in FIG. 2 and FIG. 3, the housing 11 has an opening PN. First, the user may place the light-emitting module 12 into the housing 11 through the opening PN, and then fix the light-emitting module 12 inside the housing 11 by means of a plurality of fixing members Fx.

As shown in FIG. 3, the user may then dispose the diffusion plate 13 on the housing 11 and secure the diffusion plate 13 to the housing 11 such that the diffusion plate 13 covers the light-emitting module 12.

The embodiment just exemplifies the disclosure and is not intended to limit the scope of the disclosure; any equivalent modification and variation according to the spirit of the disclosure is to be also included within the scope of the following claims and their equivalents.

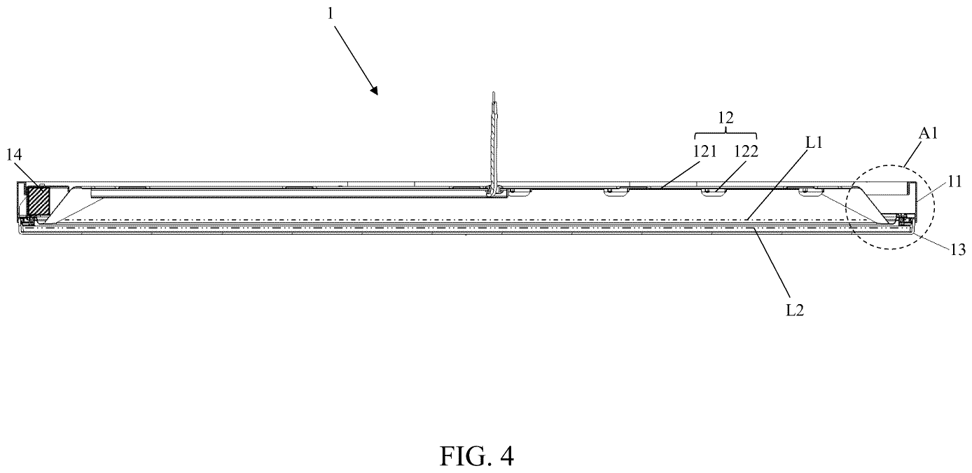

Please refer to FIG. 4, which is a sectional view of the high-luminous-efficiency frameless panel light in accordance with the first embodiment of the disclosure, and also refer to FIG. 1, FIG. 2, and FIG. 3. As shown in FIG. 4, the light-emitting module 12 includes a back plate 121 and a plurality of light sources 122. The back plate 121 is disposed inside the housing 11 through the opening PN. The back plate 121 has a light outlet L1 (as shown in the region indicated by the one-dot chain line in FIG. 4), and the light sources 122 are disposed inside the back plate 121 through the light outlet L1. In this embodiment, the light sources 122 may be light-emitting diodes (LEDs). In another embodiment, the light sources 122 may be a light-emitting diode array.

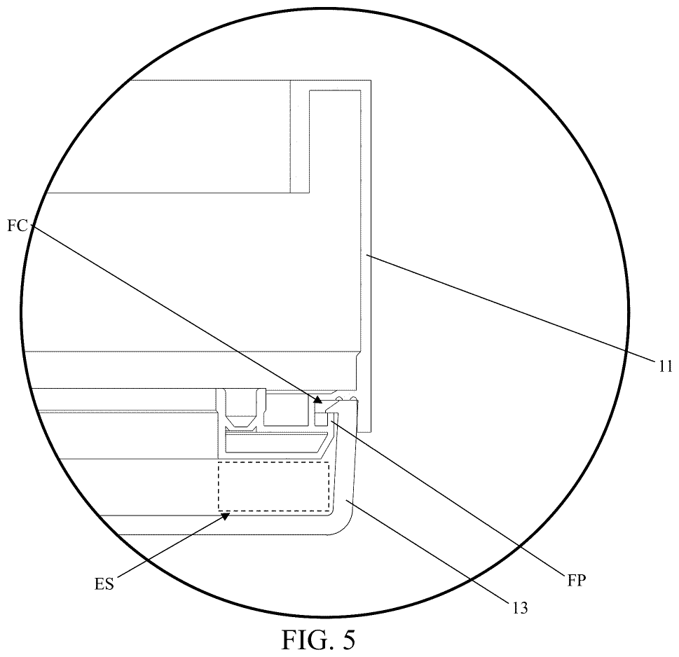

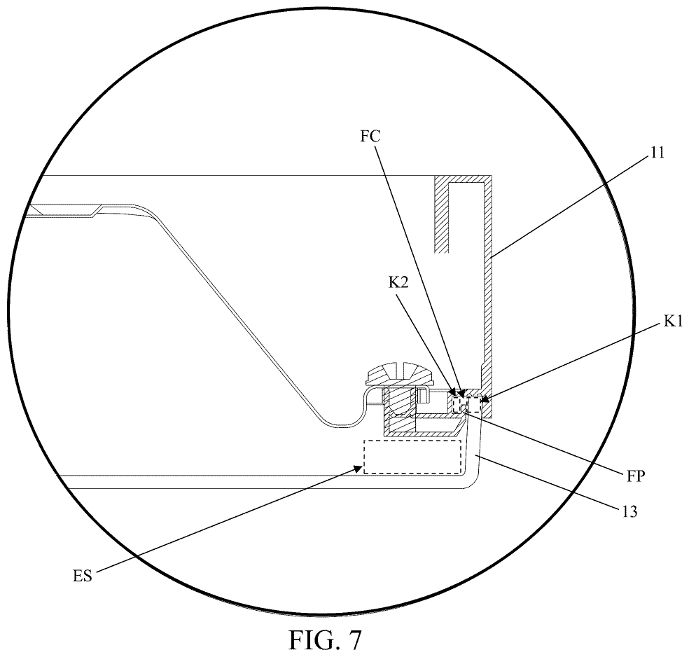

The diffusion plate 13 has a light inlet L2 (as shown in the region indicated by a two-dot chain line in FIG. 4), and the light inlet L2 is in communication with the light outlet L1. The area of the light inlet L2 is greater than the area of the light outlet L1, so that an optical extension space ES (as shown in FIG. 5 and FIG. 7) is formed between the periphery of the diffusion plate 13 and the bottom of the housing 11. In one embodiment, the diffusion plate 13 is made of a transparent material or a translucent material. In this embodiment, the diffusion plate 13 may be made of plastic. In another embodiment, the diffusion plate 13 may be made of glass.

In addition, the panel light 1 further includes a power module 14. The power module 14 is disposed inside the housing 11. In this embodiment, the power module 14 may be a power supply. In another embodiment, the power module 14 may be a battery or other similar components.

As can be seen from the above, since the area of the light inlet L2 of the diffusion plate 13 is greater than the area of the light outlet L1 of the back plate 121, the light generated by the light sources 122 enters the light inlet L2 of the diffusion plate 13 after passing through the light outlet L1, and is further diffused to the front and side surfaces of the diffusion plate 13.

Through the above special optical structure design, an optical extension space ES is formed between the periphery of the diffusion plate 13 and the bottom of the housing 11. Therefore, the bottom surface of the diffusion plate 13 may form a first light-emitting surface S1, and the side wall of the diffusion plate 13 forms a second light-emitting surface S2 (as shown in FIG. 1). The first light-emitting surface S1 (the bottom surface of the diffusion plate 13) may serve as a front light-emitting surface, and the second light-emitting surface S2 (the side wall of the diffusion plate 13) may serve as a side light-emitting surface. In this way, the panel light 1 not only has a front light-emitting function but also has a side light-emitting function, thereby increasing the overall luminous area of the panel light 1 and greatly enhancing the luminous flux. Accordingly, the luminous efficiency of the panel light 1 can be effectively improved, and the overall performance of the panel light 1 can be significantly enhanced. In addition, the panel light 1 can also achieve a frameless appearance to provide a good visual effect.

Furthermore, in this embodiment, the panel light 1 has a special optical structure design, so that the panel light 1 not only has a front light-emitting function but also a side light-emitting function. Therefore, the luminous efficiency of the panel light 1 can be effectively improved, enabling the panel light 1 to reduce energy loss and simultaneously lower carbon emissions. Thus, the panel light 1 can truly meet the demand for energy saving and power conservation.

The embodiment just exemplifies the disclosure and is not intended to limit the scope of the disclosure; any equivalent modification and variation according to the spirit of the disclosure is to be also included within the scope of the following claims and their equivalents.

Please refer to FIG. 5, which is a partially enlarged view of the high-luminous-efficiency frameless panel light in accordance with the first embodiment of the disclosure, and also refer to FIG. 1, FIG. 2, FIG. 3, and FIG. 4. FIG. 5 is an enlarged view of the region A1 of FIG. 4. As shown in FIG. 5, the outer edge of the housing 11 has a fixing channel FC and a fixing post FP.

The fixing post FP is disposed in the fixing channel FC, such that the cross-section of the fixing channel FC is U-shaped.

The inner wall of the diffusion plate 13 has a plurality of protrusions 131.

The protrusions 131 are embedded in the fixing channel FC and engaged with the fixing post FP. The fixing channel FC, the fixing post FP, and the protrusions 131 may form a screwless fixing structure. Through the structural design of the fixing channel, the diffusion plate 13 may be disposed on the housing 11 and fixed thereto by means of a simple screwless fixing structure. Therefore, the structural complexity of the panel light 1 can be greatly reduced, thereby reducing the cost of the panel light 1. At the same time, the manufacturing process of the panel light 1 can also be greatly simplified, thereby lowering the manufacturing cost of the panel light 1. As a result, the application of the panel light 1 can become more widespread.

In addition, the outer edge of the housing 11 of the panel light 1 may further have the fixing channel FC and the fixing post FP. The fixing post FP is disposed in the fixing channel FC, such that the cross-section of the fixing channel FC is U-shaped. Through the structural design of the fixing channel FC, the diffusion plate 13 may be disposed on the housing 11 and fixed thereto by means of a simple screwless fixing structure. Therefore, the structural complexity of the panel light 1 can be greatly reduced, thereby reducing the cost of the panel light 1. At the same time, the manufacturing process of the panel light 1 can also be greatly simplified, thereby lowering the manufacturing cost of the panel light 1. As a result, the application of the panel light can become more widespread. The fixing channel can not only realize a snap-fit fixing structure but also simultaneously provide a gluing groove and an overflow groove to implement an adhesive fixing structure. Therefore, the manufacturing process of the panel light can be more flexible to meet the requirements of different applications. The diffusion plate 13 can be disposed on the housing 11 and fixed thereto by various fixing methods (such as snap-fit fixing structure, ultrasonic welding, or adhesive fixing structure). Therefore, the user may select a suitable fixing method according to actual needs, so that the panel light 1 can better meet actual requirements.

The embodiment just exemplifies the disclosure and is not intended to limit the scope of the disclosure; any equivalent modification and variation according to the spirit of the disclosure is to be also included within the scope of the following claims and their equivalents.

It is worthy to point out that in currently available panel lights, the light is easily blocked by the frame, which reduces the light-emitting area of the panel light and further decreases the luminous efficiency of the panel light. In order to address the above problem, many lighting device manufacturers have designed frameless panel lights. However, most existing frameless panel lights adopt a narrow-frame structure. The above structure is achieved by shortening the frame size, but the light of the panel light is still easily blocked by the frame, and the above problem cannot be effectively solved. Some currently available frameless panel lights are provided with a side light-emitting function, but the structure for implementing the side light-emitting function is relatively complicated, which significantly increases the cost. In addition, the structure for the side light-emitting function may also cause luminous flux loss, making it impossible to achieve high luminous efficiency and failing to effectively solve the above problem. By contrast, according to one embodiment of the disclosure, the high-luminous-efficiency frameless panel light includes a housing, a light-emitting module and a diffusion plate. The housing has an opening. The light-emitting module includes a back plate disposed inside the housing through the opening and a plurality of light sources. The back plate has a light outlet, and the light sources are disposed inside the back plate through the light outlet. The diffusion plate is disposed on the housing and covers the light-emitting module. The diffusion plate has a light inlet, and the light inlet is in communication with the light outlet. The area of the light inlet is greater than the area of the light outlet. Through the above special optical structure design, the bottom surface of the diffusion plate can form a first light-emitting surface, while the side wall of the diffusion plate forms a second light-emitting surface. The first light-emitting surface can serve as a front light-emitting surface, and the second light-emitting surface can serve as a side light-emitting surface. Thus, the panel light not only has a front light-emitting function but also a side light-emitting function, thereby increasing the overall luminous area of the panel light and significantly increasing the luminous flux. Therefore, the luminous efficiency of the panel light can be effectively improved, resulting in a substantial enhancement of the overall performance of the panel light. In addition, the panel light can also achieve a frameless appearance to provide a good visual effect.

According to one embodiment of the disclosure, the panel light has a special optical structure design, so that the panel light not only has a front light-emitting function but also a side light-emitting function. Therefore, the luminous efficiency of the panel light can be effectively improved, enabling the panel light to reduce energy loss while simultaneously lowering carbon emissions. Accordingly, the panel light can meet the requirements of energy saving.

Further, according to one embodiment of the disclosure, the outer edge of the housing of the panel light is provided with a fixing channel and a fixing post. The fixing post is disposed in the fixing channel, so that the cross-section of the fixing channel is U-shaped. Through the above fixing channel structural design, the diffusion plate can be mounted on the housing and fixed thereto by means of a simple screwless fixing structure. Therefore, the structural complexity of the panel light can be greatly reduced, thereby lowering the cost of the panel light. At the same time, the manufacturing process of the panel light can also be greatly simplified, reducing the manufacturing cost of the panel light. As a result, the panel light can be more comprehensive in application.

In addition, according to one embodiment of the disclosure, the outer edge of the housing of the panel light is provided with a fixing channel and a fixing post. The fixing post is disposed in the fixing channel, so that the cross-section of the fixing channel is U-shaped. Through the above fixing channel structural design, the fixing channel can not only realize a snap-fit fixing structure but can also simultaneously provide a gluing groove and an overflow groove to achieve an adhesive fixing structure. Therefore, the manufacturing process of the panel light can be more flexible to meet the requirements of different applications.

Moreover, according to one embodiment of the disclosure, the outer edge of the housing of the panel light is provided with a fixing channel and a fixing post. The fixing post is disposed in the fixing channel, so that the cross-section of the fixing channel is U-shaped. Through the above fixing channel structural design, the diffusion plate can be mounted on the housing and fixed thereto by various fixing methods, such as a snap-fit fixing structure, ultrasonic welding, or adhesive fixing structure. Therefore, the user can select a suitable fixing method according to actual needs, so that the panel light can better meet the requirements of practical applications.

Furthermore, according to one embodiment of the disclosure, the panel light has a simple design, and thus the desired effects can be achieved while reducing costs. Therefore, the practicality of the panel light can be greatly improved, and the panel light can conform to the future development trend. As described above, the high-efficiency frameless panel light according to the embodiments of the disclosure can definitely achieve great technical effects.

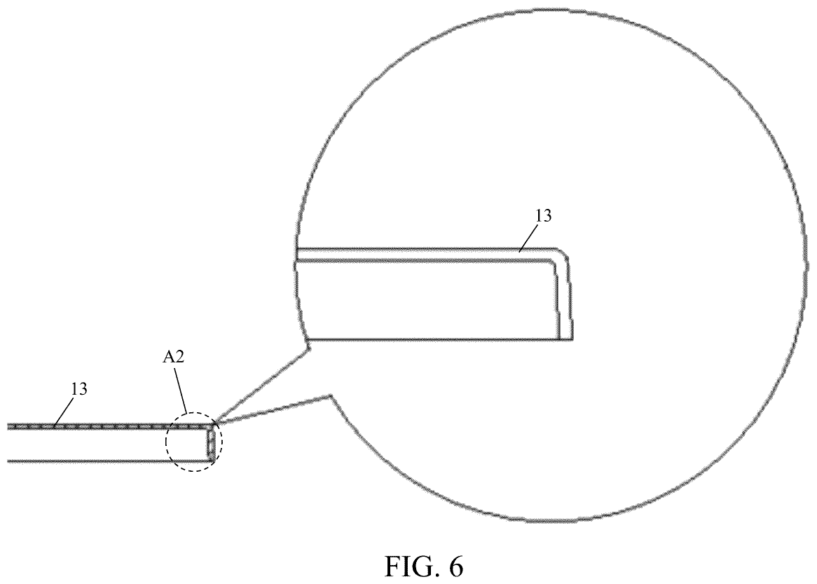

Please refer to FIG. 6, which is a first partially enlarged view of a high-luminous-efficiency frameless panel light in accordance with a second embodiment of the disclosure. Please also refer simultaneously to FIG. 1, FIG. 2, FIG. 3, and FIG. 4. FIG. 6 is an enlarged view of the region A2 of the diffusion plate 13. As shown in FIG. 6, all four edges of the diffusion plate 13 are curved (with a rounded-corner design). The difference between this embodiment and the previous embodiment is that the diffusion plate 13 does not have the protrusions 131.

The embodiment just exemplifies the disclosure and is not intended to limit the scope of the disclosure; any equivalent modification and variation according to the spirit of the disclosure is to be also included within the scope of the following claims and their equivalents.

Please refer to FIG. 7, which is a second partially enlarged view of the high-luminous-efficiency frameless panel light in accordance with the second embodiment of the disclosure. Please also refer simultaneously to FIG. 1, FIG. 2, FIG. 3, FIG. 4, and FIG. 6. FIG. 7 is an enlarged view of the region A1 in FIG. 4, but the structure of the diffusion plate 13 in this embodiment is different from that of the foregoing embodiment.

The portion of the fixing channel FC located to the right side of the fixing post FP can serve as a gluing groove K1, while the portion of the fixing channel FC located to the left side of the fixing post FP can serve as an overflow groove K2. Therefore, the fixing channel FC can simultaneously provide the functions of the gluing groove K1 and the overflow groove K2.

The user may fill adhesive into the gluing groove K1 of the fixing channel FC, and then insert the outer edge of the diffusion plate 13 into the gluing groove K1 of the fixing channel FC. In this way, the outer edge of the diffusion plate 13 can be fixed in the gluing groove K1 of the fixing channel FC by means of adhesive. The excess adhesive will be squeezed into the overflow groove K2 instead of overflowing out of the fixing channel FC.

In another embodiment, the outer edge of the diffusion plate 13 may also be directly fixed within the fixing channel FC by ultrasonic welding (or other similar fixing methods).

As set forth above, the outer edge of the housing 11 of the panel light 1 is provided with the fixing channel FC and the fixing post FP. The fixing post FP is disposed within the fixing channel FC such that the cross-section of the fixing channel FC is U-shaped. Through the design of the fixing channel FC, the fixing channel FC not only provides a snap-fit fixing structure, but also simultaneously provides the functions of the gluing groove K1 and the overflow groove K2 to achieve an adhesive fixing structure. Therefore, the manufacturing process of the panel light 1 can be more flexible to meet the requirements of different applications.

In addition, according to this embodiment of the present utility model, the outer edge of the housing 11 of the panel light 1 is provided with the fixing channel FC and the fixing post FP. The fixing post FP is disposed within the fixing channel FC such that the cross-section of the fixing channel FC is U-shaped. Through the design of the fixing channel FC, the diffusion plate 13 can be fixed to the housing 11 in various fixing manners (such as snap-fit fixing, ultrasonic welding, or adhesive fixing). Accordingly, the user may select a suitable fixing method according to actual requirements, so that the panel light 1 can better meet practical application demands.

Similarly, the panel light 1 of this embodiment also has a special optical structure design. Through this optical structure design, the bottom surface of the diffusion plate 13 can form a first light-emitting surface S1, while the side wall of the diffusion plate 13 forms a second light-emitting surface S2. The first light-emitting surface S1 may serve as a front light-emitting surface, while the second light-emitting surface S2 may serve as a side light-emitting surface. Thus, the panel light 1 not only has a front light-emitting function but also a side light-emitting function, which increases the overall luminous area of the panel light 1, thereby significantly increasing luminous flux. Therefore, the luminous efficiency of the panel light 1 can be effectively improved, resulting in a substantial enhancement of overall performance. In addition, the panel light 1 can achieve a frameless appearance to provide a great visual effect.

The embodiment just exemplifies the disclosure and is not intended to limit the scope of the disclosure; any equivalent modification and variation according to the spirit of the disclosure is to be also included within the scope of the following claims and their equivalents.

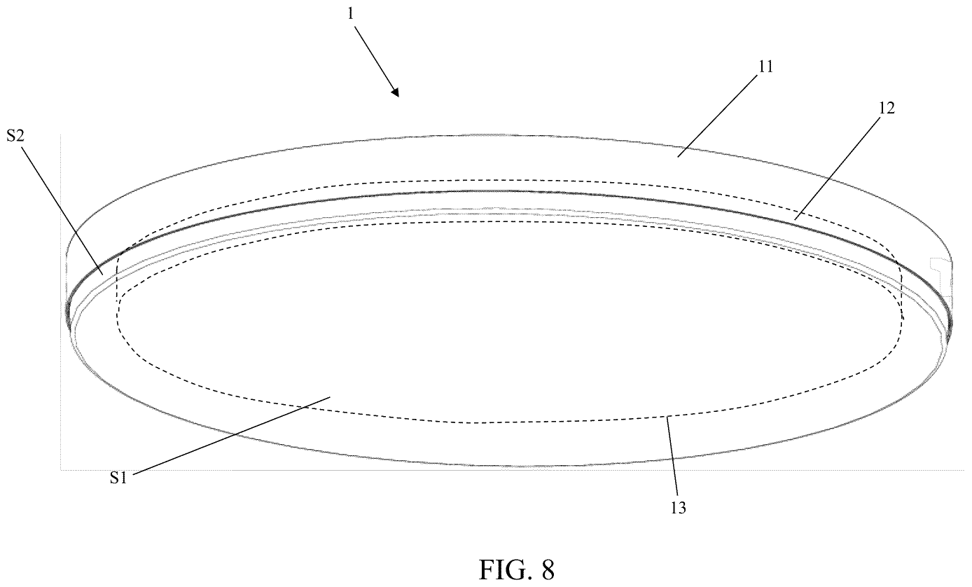

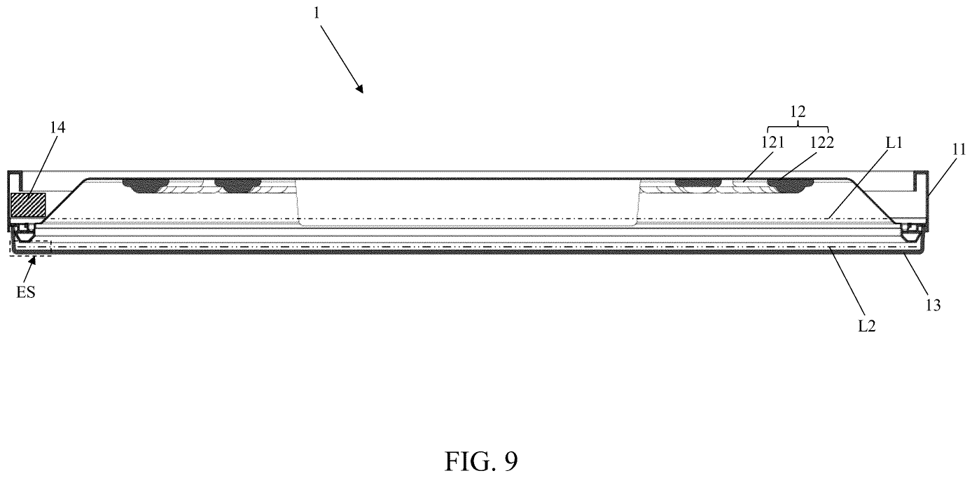

Please refer to FIG. 8 and FIG. 9. FIG. 8 is a perspective view of a high-luminous-efficiency frameless panel light in accordance with a third embodiment of the disclosure. FIG. 9 is a sectional view of the high-luminous-efficiency frameless panel light in accordance with the third embodiment of the disclosure. As shown FIG. 8 and FIG. 9, the panel light 1 includes a housing 11, a light-emitting module 12, and a diffusion plate 13. The light-emitting module 12 is disposed inside the housing 11, while the diffusion plate 13 is disposed on the housing 11 and covers the light-emitting module 12.

The difference between this embodiment and the previous embodiment is that the panel light 1 is circular. That is, the housing 11 and the diffusion plate 13 are also circular.

The shape of the panel light 1 may be designed according to actual requirements and is not limited to the shapes of the foregoing embodiments.

The light-emitting module 12 includes a back plate 121 and a plurality of light sources 122. The back plate 121 is disposed within the housing 11. The back plate 121 has a light outlet L1 (as shown in the region indicated by the one-dot chain line in FIG. 9), and the light sources 122 are disposed inside the back plate 121 through the light outlet L1. In this embodiment, the light sources 122 may be light-emitting diodes (LEDs). In another embodiment, the light sources 122 may be a light-emitting diode array.

The diffusion plate 13 has a light inlet L2 (as shown in the region indicated by the two-dot chain line in FIG. 9). The light inlet L2 is in communication with the light outlet L1. The area of the light inlet L2 is larger than the area of the light outlet L1, thereby forming an optical extension space ES between the periphery of the diffusion plate 13 and the bottom of the housing 11, as shown in FIG. 5 and FIG. 7. In one embodiment, the diffusion plate 13 is made of a transparent material or a translucent material. In this embodiment, the diffusion plate 13 may be made of plastic. In another embodiment, the diffusion plate 13 may be made of glass.

In addition, the panel light 1 further includes a power module 14. The power module 14 is disposed inside the housing 11. In this embodiment, the power module 14 may be a power supply. In another embodiment, the power module 14 may also be a battery or other similar components.

Similarly, since the area of the light inlet L2 of the diffusion plate 13 is larger than the area of the light outlet L1 of the back plate 121, the light generated by the light sources 122 passes through the light outlet L1 and then enters the light inlet L2 of the diffusion plate 13, and subsequently diffuses toward both the front and side surfaces of the diffusion plate 13.

Through the above-described special optical structure design, the optical extension space ES is formed between the periphery of the diffusion plate 13 and the bottom of the housing 11. Therefore, the bottom surface of the diffusion plate 13 can form a first light-emitting surface S1, while the side wall of the diffusion plate 13 forms a second light-emitting surface S2 (as shown in FIG. 8). The first light-emitting surface S1 (the bottom surface of the diffusion plate 13), may serve as a front light-emitting surface, while the second light-emitting surface S2 (the side wall of the diffusion plate 13) may serve as a side light-emitting surface. Thus, the panel light 1 not only has a front light-emitting function but also a side light-emitting function, which increases the overall luminous area of the panel light 1, thereby significantly increasing luminous flux. Therefore, the luminous efficiency of the panel light 1 can be effectively improved, resulting in a substantial enhancement of overall performance. In addition, the panel light 1 can achieve a frameless appearance to provide a desirable visual effect.

Furthermore, in this embodiment, the panel light 1 has a special optical structure design, so that the panel light 1 not only has a front light-emitting function but also a side light-emitting function. Therefore, the luminous efficiency of the panel light 1 can be effectively improved, enabling the panel light 1 to save energy consumption and simultaneously reduce carbon emissions. Accordingly, the panel light 1 can indeed meet the demand for energy-saving applications.

As can be understood from the above, the panel light 1 of this embodiment is circular. The panel light 1 of this embodiment may also be rectangular, as shown in the foregoing embodiments. The shape of the panel light 1 may be designed according to actual requirements. For example, the panel light 1 may also be polygonal (such as pentagonal, hexagonal, etc. ,) and is not limited to the shapes of the foregoing embodiments. The panel lights 1 of different shapes may all adopt the above-described optical structure design to achieve the same effect.

The embodiment just exemplifies the disclosure and is not intended to limit the scope of the disclosure; any equivalent modification and variation according to the spirit of the disclosure is to be also included within the scope of the following claims and their equivalents.

To sum up, according to one embodiment of the disclosure, the high-luminous-efficiency frameless panel light includes a housing, a light-emitting module and a diffusion plate. The housing has an opening. The light-emitting module includes a back plate disposed inside the housing through the opening and a plurality of light sources. The back plate has a light outlet, and the light sources are disposed inside the back plate through the light outlet. The diffusion plate is disposed on the housing and covers the light-emitting module. The diffusion plate has a light inlet, and the light inlet is in communication with the light outlet. The area of the light inlet is greater than the area of the light outlet. Through the above special optical structure design, the bottom surface of the diffusion plate can form a first light-emitting surface, while the side wall of the diffusion plate forms a second light-emitting surface. The first light-emitting surface can serve as a front light-emitting surface, and the second light-emitting surface can serve as a side light-emitting surface. Thus, the panel light not only has a front light-emitting function but also a side light-emitting function, thereby increasing the overall luminous area of the panel light and significantly increasing the luminous flux. Therefore, the luminous efficiency of the panel light can be effectively improved, resulting in a substantial enhancement of the overall performance of the panel light. In addition, the panel light can also achieve a frameless appearance to provide a good visual effect.

According to one embodiment of the disclosure, the panel light has a special optical structure design, so that the panel light not only has a front light-emitting function but also a side light-emitting function. Therefore, the luminous efficiency of the panel light can be effectively improved, enabling the panel light to reduce energy loss while simultaneously lowering carbon emissions. Accordingly, the panel light can meet the requirements of energy saving.

Further, according to one embodiment of the disclosure, the outer edge of the housing of the panel light is provided with a fixing channel and a fixing post. The fixing post is disposed in the fixing channel, so that the cross-section of the fixing channel is U-shaped. Through the above fixing channel structural design, the diffusion plate can be mounted on the housing and fixed thereto by means of a simple screwless fixing structure. Therefore, the structural complexity of the panel light can be greatly reduced, thereby lowering the cost of the panel light. At the same time, the manufacturing process of the panel light can also be greatly simplified, reducing the manufacturing cost of the panel light. As a result, the panel light can be more comprehensive in application.

In addition, according to one embodiment of the disclosure, the outer edge of the housing of the panel light is provided with a fixing channel and a fixing post. The fixing post is disposed in the fixing channel, so that the cross-section of the fixing channel is U-shaped. Through the above fixing channel structural design, the fixing channel can not only realize a snap-fit fixing structure but can also simultaneously provide a gluing groove and an overflow groove to achieve an adhesive fixing structure. Therefore, the manufacturing process of the panel light can be more flexible to meet the requirements of different applications.

Moreover, according to one embodiment of the disclosure, the outer edge of the housing of the panel light is provided with a fixing channel and a fixing post. The fixing post is disposed in the fixing channel, so that the cross-section of the fixing channel is U-shaped. Through the above fixing channel structural design, the diffusion plate can be mounted on the housing and fixed thereto by various fixing methods, such as a snap-fit fixing structure, ultrasonic welding, or adhesive fixing structure. Therefore, the user can select a suitable fixing method according to actual needs, so that the panel light can better meet the requirements of practical applications.

Furthermore, according to one embodiment of the disclosure, the panel light has a simple design, and thus the desired effects can be achieved while reducing costs. Therefore, the practicality of the panel light can be greatly improved, and the panel light can conform to the future development trend.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is

1. A high-luminous-efficiency frameless panel light, comprising:
a housing having an opening;
a light-emitting module comprising a back plate disposed inside the housing through the opening and a plurality of light sources, wherein the back plate has a light outlet, and the light sources are disposed inside the back plate through the light outlet; and
a diffusion plate disposed on the housing and covering the light-emitting module, wherein the diffusion plate has a light inlet, and the light inlet is in communication with the light outlet;
wherein an area of the light inlet is greater than an area of the light outlet.

2. The high-luminous-efficiency frameless panel light as claimed in claim 1, wherein an outer edge of the housing has a fixing channel and a fixing post disposed in the fixing channel, whereby a cross-section of the fixing channel is U-shaped.

3. The high-luminous-efficiency frameless panel light as claimed in claim 2, wherein an inner wall of the diffusion plate has a plurality of protrusions embedded in the fixing channel and engaged with the fixing post.

4. The high-luminous-efficiency frameless panel light as claimed in claim 2, wherein an adhesive is provided in the fixing channel, and an outer edge of the diffusion plate is embedded in the fixing channel and fixed therein by the adhesive.

5. The high-luminous-efficiency frameless panel light as claimed in claim 2, wherein an outer edge of the diffusion plate is fixed in the fixing channel by ultrasonic welding.

6. The high-luminous-efficiency frameless panel light as claimed in claim 1, wherein the back plate is fixed inside the housing by a plurality of fixing members.

7. The high-luminous-efficiency frameless panel light as claimed in claim 1, wherein a bottom surface of the diffusion plate forms a first light-emitting surface, and a side wall of the diffusion plate forms a second light-emitting surface.

8. The high-luminous-efficiency frameless panel light as claimed in claim 1, wherein the light sources are light-emitting diodes or light-emitting diode arrays.

9. The high-luminous-efficiency frameless panel light as claimed in claim 1, further comprising a power module disposed inside the housing.

10. The high-luminous-efficiency frameless panel light as claimed in claim 1, wherein the diffusion plate is made of a transparent material or a translucent material.
